(19) United States
(12) Patent Application Publication
(10) Pub. No.: US 2024/0177461 A1
(43) Pub. Date: May 30, 2024

(54) TEACHING DEVICE

(71) Applicant: FANUC CORPORATION, Yamanashi (JP)

(72) Inventors: Misaki ITO, Yamanashi (JP); Yuta NAMIKI, Yamanashi (JP)

(21) Appl. No.: 18/553,203

(22) PCT Filed: Jun. 23, 2021
(86) PCT No.: PCT/JP2021/023866

§ 371 Date: Sep. 29, 2023

(51) Int. Cl. G06V 10/774; B25J 9/16; G06T 7/00; G06V 10/94

(52) U.S. Cl. CPC G06V 10/774; B25J 9/163; B25J 9/1697; G06T 7/0004; G06V 10/945; G06T 2200/24; G06T 2207/20081; G06T 2207/20092; G06T 2207/30164

(57) ABSTRACT

Provided is a teaching device comprising a determination unit that determines whether or not a storage condition relating to the result of processing a designated object by a visual sensor is satisfied, and a history storage unit that stores history information indicating the result of processing into a storage device if the storage condition is determined to be satisfied.

### FIELD

The present invention relates to a teaching device.

### BACKGROUND

A vision detection function is known to detect a specific object in an image in the field of view using an imaging device and to obtain the position information of the detected object. Such a vision detection function is generally also provided with a function to save the detection results as an execution history.

In this regard, PTL 1 discloses an information management system in which “the equipment control system 10 notifies the image processing system 20 of the timing when the image of the workpiece 82 to be processed should be captured (hereinafter referred to as “capture timing”) in each process, and identification information which is information for identifying (specifying) the workpiece 82 corresponding to the notification is sent from the equipment control system 10 to the image processing system 20″ (see paragraph 0032).

### CITATION LIST

### Patent Literature

[PTL 1] Japanese Unexamined Patent Publication (Kokai) No. 2021-22296A

### SUMMARY

### Technical Problem

In the history information storage function of the vision detection function, it is desirable to be able to store the history information under flexible conditions, and to be able to suppress consumption of memory capacity and increase of cycle time associated with storage of the history information.

### Solution to Problem

One aspect of the present disclosure is a teaching device including a determination unit configured to determine whether a storage condition related to a result of processing on an object by a visual sensor is satisfied, and a history storage unit configured to store history information obtained as the result of the processing in a storage device when the storage condition is determined to be satisfied.

### Advantageous Effects of Invention

According to the configuration described above, the history information can be stored under flexible conditions, and consumption of memory capacity and increase of cycle time associated with storage of the history information can be suppressed.

From the detailed description of typical embodiments of the present invention illustrated in the accompanying drawings, these and other objects, features and advantages of the present invention will be further clarified.

### BRIEF DESCRIPTION OF DRAWINGS

FIG. 1 is a diagram illustrating overall configuration of a robot system including a teaching device according to an embodiment of the present invention.

FIG. 2 is a diagram illustrating an example of a hardware configuration of a robot controller and a teach pendant.

FIG. 3 is a block diagram illustrating functional configurations of the teach pendant and the robot controller (teaching device).

FIG. 4 is a flow chart illustrating processes of executing saving of a history information by a vision detection function (vision detection process and history saving process) based on predetermined storage condition.

FIG. 5 is a diagram illustrating an example of a program in the case of realizing the vision detection process and history storage process as a text-based program.

FIG. 6 is a diagram illustrating an example of a program in the case of creating the vision detection process and history storage process by command icons.

FIG. 7 is a diagram illustrating a user interface screen for detailed setting of condition determination icons.

FIG. 8 is a diagram illustrating a user interface screen for setting of vision detection icons.

FIG. 9 is a diagram illustrating a condition setting screen for specifying storage conditions.

FIG. 10A is a diagram illustrating an example of setting storage conditions using the condition setting screen.

FIG. 10B is a diagram illustrating a case of setting a detection position in an image as the storage conditions.

FIG. 11 is a diagram illustrating an operation in a case of saving the history information when outliers are detected.

FIG. 12 is a diagram illustrating an example of a configuration in a case of inputting the history image to a convolutional neural network as input data for learning.

FIG. 13A is a diagram illustrating a configuration for learning using teacher data in which history images as input data and that whether the history image has been saved or not as an output label.

FIG. 13B is a diagram illustrating a configuration for learning using teacher data in which history images as input data and storage destination as an output label.

### DESCRIPTION OF EMBODIMENTS

The embodiments of the present disclosure will now be described with reference to the drawings. In the drawings to be referenced, same reference numbers are assigned for same component parts or functional parts. For ease of understanding, the scale of these drawings has been changed as appropriate. The forms illustrated in the drawings is one example for implementing the present invention, and the present invention is not limited to the forms illustrated therein.

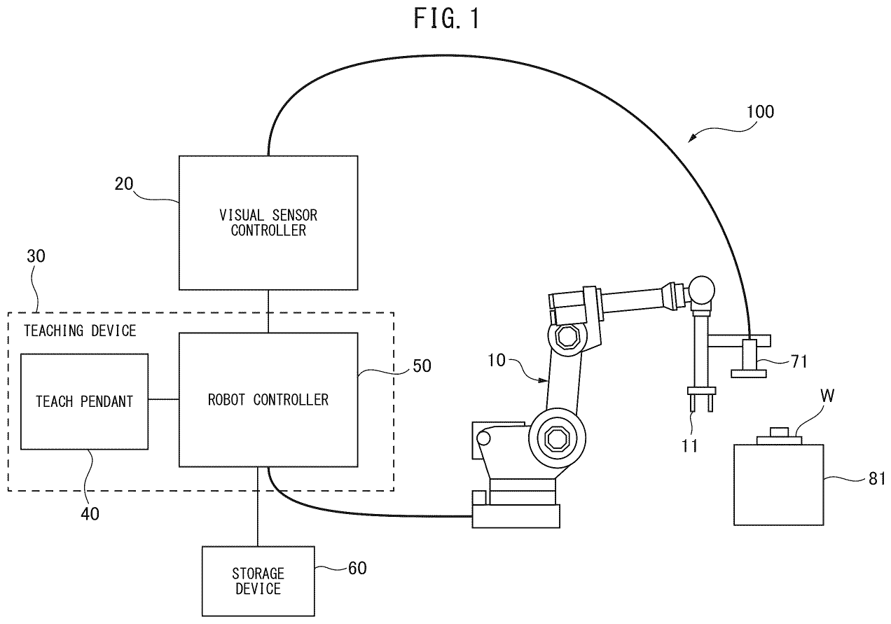

FIG. 1 is a diagram illustrating an overall configuration of a robot system including a teaching device 30 according to an embodiment of the present invention. The robot system 100 includes a robot 10, a visual sensor controller 20, a robot controller 50 that controls the robot 10, a teach pendant 40, and a storage device 60. A hand 11 as an end effector is mounted on an arm end of the robot 10. A visual sensor 71 is mounted on the arm end of the robot 10. The visual sensor controller 20 controls the visual sensor 71. The robot system 100 can detect an object (workpiece W) placed on the worktable 81 by the visual sensor 71 to compensate the position of the robot 10 and perform handling of the workpiece W. The function of detecting the object using the visual sensor 71 can be referred herein to as the vision detection function.

In the robot system 100, the teach pendant 40 is used as an operation terminal for performing various types of teachings (i.e., programming) for the robot 10. Once a robot program generated using the teach pendant 40 is registered in the robot controller 50, the robot controller 50 can thereafter execute control of the robot 10 in accordance with the robot program. In this embodiment, the functions of the teach pendant 40) and the robot controller 50 are assumed to be configured as a teaching device 30. The functions of the teaching device 30 include a function of teaching positions and postures to the robot 10 (function as a programming device) and a function of controlling the robot 10 in accordance with the contents of the teaching.

In this embodiment, according to the storage conditions related to the results of the processing on the object by the visual sensor 71, the teaching device 30 is configured to determine whether to save the history information obtained as a result of executing the processing on the object by the visual sensor 71. Here, the processing of the object by the visual sensor 71 may include detection of the object, determination concerning the object, and various other processing using the functions of the visual sensor 71. In this embodiment, the vision detection function will be taken as an example for explanation. The teaching device 30 provides the function of programming to realize such functions. Such function provided by the teaching device 30 enables history information to be stored under flexible storage conditions, and also suppresses consumption of memory capacity and increase of cycle time associated with storage of the history information. The history information obtained as a result of the execution of the vision detection function is assumed to include the captured image (history image), various information related to the quality of the history image, information related to the results of image processing such as pattern matching, and other various data generated by the execution of the vision detection function.

The storage device 60 is connected to the robot controller 50 and stores history information obtained as the result of the execution of the vision detection function by the visual sensor 71. The storage device 60 may further be configured to store setting information of the visual sensor 71, programs for vision detection, setting information, and various other information. The storage device 60 may be an external storage device (USB memory) or the like of the robot controller 50, or it may be a computer, file server, or other device for data storage connected to the robot controller 50 via a network. In FIG. 1, as an example, the storage device 60 is configured as a device provided separately from the robot controller 50, however, the storage device 60 may be configured as an internal storage device of the robot controller 50 or of the teach pendant 40. The storage device 60 may be included in the function as the teaching device 30.

The visual sensor controller 20 has functions to control the visual sensor 71 and to perform image processing on images captured by the visual sensor 71. The visual sensor controller 20 detects the workpiece W from the image captured by the visual sensor 71 and provides the detected position of the workpiece W to the robot controller 50. This allows the robot controller 50 to correct the teaching position to perform picking up, etc. of the workpiece W. The visual sensor 71 may be a camera that obtains grayscale images or color images (2-D camera), or a stereo camera or 3-D sensor that can obtain distance images or 3-D point clouds. The visual sensor controller 20 holds a model pattern of the workpiece W and performs image processing to detect the object by patter matching between the image of the object in the captured image and the model pattern. The visual sensor controller 20 may hold calibration data obtained by calibrating the visual sensor 71. The calibration data includes information on the relative position of the visual sensor 71 (sensor coordinate system) with respect to the robot 10 (e.g., robot coordinate system) as a reference. In FIG. 1, the visual sensor controller 20 is configured as a separate device from the robot controller 50, however, the function as the visual sensor controller 20 may be incorporated within the robot controller 50.

As a configuration for detecting a workpiece W using a visual sensor 71 in the robot system 100, other than the configuration illustrated in FIG. 1, there can be a configuration in which the visual sensor 71 is installed at a fixed position in the workspace. In this case, the robot system 100 may be configured such that the workpiece W is grasped by a hand tip of the robot 10 and shown to the visual sensor 71 installed in a fixed position.

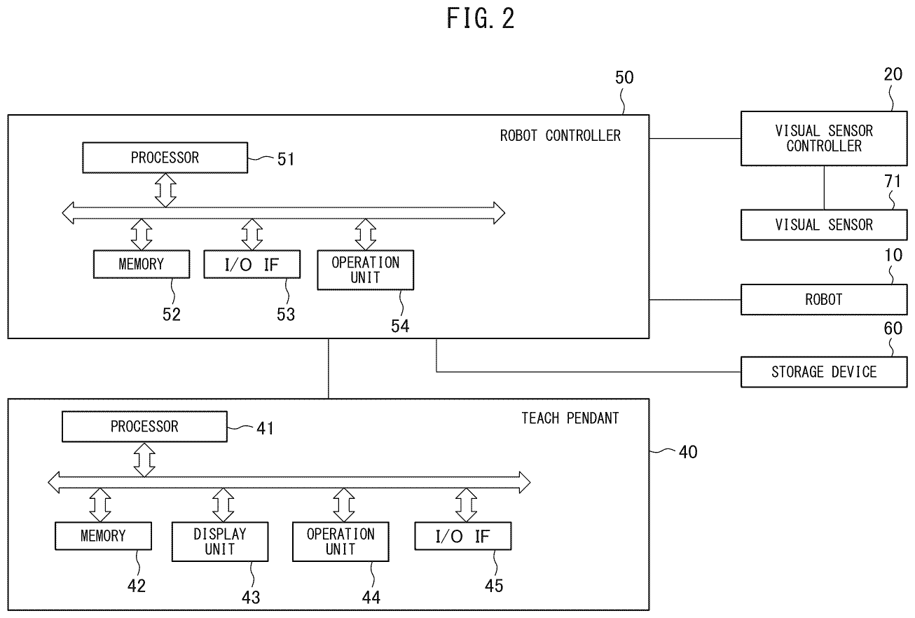

FIG. 2 is a diagram illustrating an example of a hardware configuration of the robot controller 50 and the teach pendant 40. The robot controller 50 may be configured as a general computer with a memory 52 (ROM, RAM, nonvolatile memory, etc.), an input/output interface 53, and an operation unit 54 including various operation switches connected to a processor 51 via a bus. The teach pendant 40 may be configured as a general computer with a memory 42 (ROM, RAM, nonvolatile memory, etc.), a display unit 43, an operation unit 44 formed of an input device such as a keyboard (or software keys), an input/output interface 45, etc. connected to a processor 41 via a bus. A tablet terminal, a smart phone, a personal computer, or various other information processing devices can be used as the teach pendant 40.

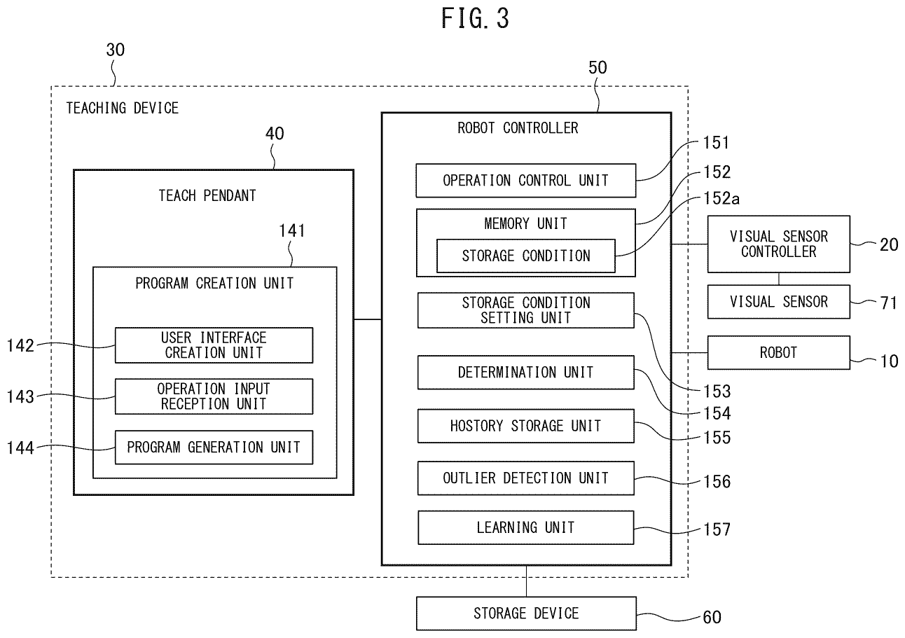

FIG. 3 is a block diagram illustrating a functional configuration composed by the teach pendant 40) and the robot controller 50 (i.e., a functional configuration as the teaching device 30). As illustrated in FIG. 3, the robot controller 50 has an operation control unit 151 that controls the operation of the robot 10 in accordance with the robot program, etc., a memory unit 152, a storage condition setting unit 153, a determination unit 154, a history storage unit 155, an outlier detection unit 156 and a learning unit 157.

The memory unit 152 stores the robot program and various other information. The memory unit 152 may also be configured to store storage conditions (marked with a reference number 152a in FIG. 3) set by the storage condition setting unit 153.

The storage condition setting unit 153 provides a function for setting storage conditions for storing the history information. The function for setting storage conditions by the storage condition setting unit 153 is realized by the collaboration of a function for accepting storage condition settings in programming via the function of a program creation unit 141 and a function for setting the storage condition in the robot controller 50 by registering, in the robot controller 50, the program created by the function of the program creation unit 141. Programming here includes programming by using text-based commands and programming by using command icons. These types of programming are described later.

The determination unit 154 determines whether the storage conditions are satisfied. The history storage unit 155 saves the history information in the storage device 60 when the determination unit 154 determines that the storage conditions are satisfied.

The outlier detection unit 156 provides the function of detecting whether the value is an outlier with respect to data (parameters) included in the history information obtained as a result of execution of the vision detection function. The learning unit 157 provides the function of learning the storage conditions based on the history information.

Each function of the robot controller 50 illustrated in FIG. 3 may be realized, for example, by registering the programs (robot programs, programs for vision detection functions, etc.) created by the teach pendant 40 in the robot controller 50 and having the processor 51 of the robot controller 50 execute these programs. It is also possible to install at least some of the functions as the memory unit 152, the storage condition setting unit 153, the determination unit 154, the history storage unit 155, the outlier detection unit 156, and the learning unit 157 of the robot controller 50 into the visual sensor controller 20. In this case, the visual sensor controller 20 may be included in the function as the teaching device 30.

The teach pendant 40 has the program creation unit 141 for creating various programs, such as robot programs for the robot 10 and programs to realize the vision detection function (hereinafter also referred to as “vision detection programs”). The program creation unit 141 includes a user interface creation unit 142 (hereinafter referred to as a “UI creation unit 142”) that creates and displays a user interface for performing various inputs related to programming including command inputs and detailed settings related to commands, an operation input reception unit 143 that receives various user operations through the user interface, and a program generation unit 144 that generates a program based on the input commands and settings.

Through the program generation function by the teach pendant 40, a user can create the robot programs for controlling the robot 10 and the vision detection programs. Once the vision detection programs are created and registered in the robot controller 50, the robot controller 50 can thereafter execute the robot programs including the vision detection programs and execute the task of handling the workpiece W while detecting the workpiece W using the visual sensor 71.

In this embodiment, a user can create, via the function of the program creation unit 141, a program for saving history information obtained as the result of executing the vision detection function when the storage conditions are satisfied. Once such a program is registered in the robot controller 50, the robot controller 50 can thereafter operate to save the history information only when the storage conditions are satisfied. This can suppress consumption of memory capacity and increase of cycle time associated with storage of the history information.

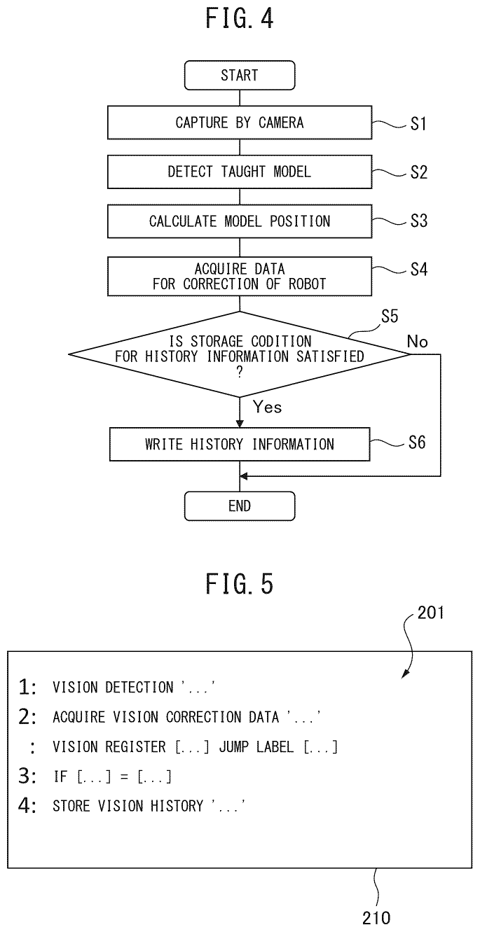

FIG. 4 is a flowchart illustrating a process (the vision detection and the history saving process) for saving, based on the storage conditions, the history information obtained by the vision detection function implemented in the robot controller 50. The vision detection and the history storage process is executed, for example, under the control of the processor 51 of the robot controller 50. The process illustrated in FIG. 4 is for a single workpiece W. If there are multiple workpieces to be processed, the process illustrated in FIG. 4 can be performed for each workpiece.

When the vision detection and the history storage process is started, first, the workpiece W is captured by the visual sensor 71 (camera) (step S1). Next, detection of the workpiece model (i.e., detection of workpiece W) using pattern matching, etc. with the taught workpiece model is performed on the captured image (step S2). Next, the position of the workpiece model (i.e., the position of workpiece W) is calculated based on the detection result of the workpiece W (step S3). The position of the workpiece model (the position of workpiece W) is calculated, for example, as a position in the robot coordinate system.

Once the position of the model (workpiece W) is calculated, next, correction data for correcting the position of the robot 10 is calculated (step S4). The correction data is, for example, data to correct the teaching points.

Next, the robot controller 50 determines whether the storage conditions for storing the history information are satisfied (step S5). The process of step S5 corresponds to the function of the determination unit 154. If the storage conditions are satisfied (S5: YES), the robot controller 50 writes the history information to the storage device 60 (step S6) and exits this process. The process of step S6 corresponds to the function of the history storage unit 155. After exiting this process, this process may be executed continuously for the next workpiece W. On the other hand, if the storage conditions are not satisfied (S5: NO), this process ends without saving the history information.

The program for executing the vision detection and the history storage process as illustrated in FIG. 4 can be created as a text-based program or as a program described by command icons through the function of the program creation unit 141 of the teach pendant 40. As a main function, the UI creation unit 142 provides various user interfaces for programming using command icons on the screen of the display unit 43. User interfaces provided by the UI creation unit 142 include detailed setting screens for detailed settings related to the command icons. Examples of such interface screens are described below.

The operation input reception unit 143 accepts various operation inputs to the program creation screen. For example, the operation input reception unit 143 accepts operations to input text-based commands on the program creation screen, to select a desired command icon from a list of command icons and place it on the program creation screen, to select a command icon and display a detailed setting screen for detailed settings for the selected command icon, and to input detailed settings via the user interface screen.

FIG. 5 illustrates a program 201 as an example of when the vision detection and history storage process of FIG. 4 is realized in a form of a text-based program. In the program 201 in FIG. 5, the number to the left of each line represents a line number. When creating the text-based program 201 as illustrated in FIG. 5, a user enters commands on the program creation screen 210 provided by the program creation unit 141.

The command in the first line “VISION DETECTION ‘ . . . ’” is a command corresponding to the process of steps S1 to S3 in FIG. 4 and corresponds to the process of capturing the workpiece W using the visual sensor 71, detecting the workpiece W from the captured image by using the taught workpiece model, and detecting the position of the model (position of the workpiece W). A user is allowed to specify the name of the program (macro name) that executes this process to the field “ . . . ” after the command “VISION DETECTION”.

The command in the second line “ACQUIRE VISION CORRECTION DATA” is a command corresponding to the process of step S4 in FIG. 4, which calculates data to correct the teaching point based on the detection result of the workpiece position. A user is allowed to specify the name of the program (macro name) that executes this process to the field “ . . . ” after the command “ACQUIRE VISION CORRECTION DATA”. The next command “VISION REGISTER [ . . . ]” specifies the vision register number where the correction data is stored. The 3D position of the teaching point after correction is stored in the vision register specified here.

The command in the third line “IF [ . . . ]=[ . . . ]” corresponds to the process of step S5 in FIG. 4 and is a command to specify the storage condition. When the storage conditions specified here are met, the command for the history storage in the fourth line, “STORE VISION HISTORY ‘ . . . ’” is executed. If the storage conditions are not met, the history storage command in the fourth line is not executed. Thereby, by using the vision register specified here, it is possible to correct the robot position in the robot program. In addition, after the command to specify the vision register, the command “JUMP LABEL [ . . . ]” to jump to the specified label may be described in order to execute other processes.

The command in the fourth line “STORE VISION HISTORY ‘ . . . ’” corresponds to the process of step S6 in FIG. 4 and is a command to save the history information obtained as a result of the execution of the above vision detection function. A user is allowed to specify the destination for saving the history information in the field “ . . . ” after this command.

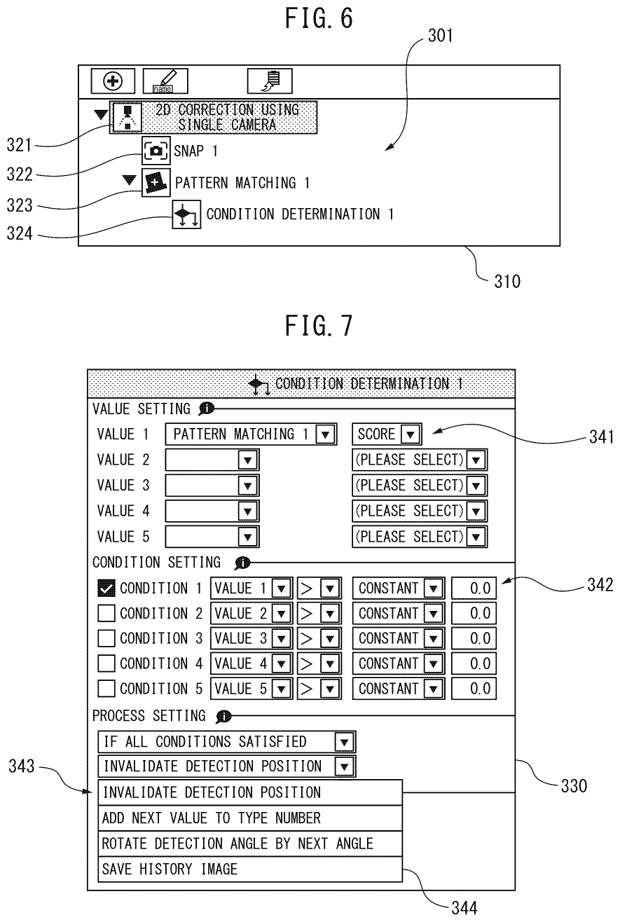

FIG. 6 illustrates a vision detection program 301 as an example of when the vision detection and history storage process of FIG. 4 is realized by using the command icons. When creating the vision detection program 301 as illustrated in FIG. 6, a user places icons on the program creation screen 310 provided by the UI creation unit 142 for programming. Here, an example is illustrated in which the icons are arranged from top to bottom in the order of execution.

The vision detection program 301 is formed of the following icons.
Vision Detection Icon 321
Snap Icon 322
Pattern Matching Icon 323
Condition Determination Icon 324

The vision detection icon 321 is an icon that has a supervising function of instructing the robot controller 50 to perform the robot position corrections based on vision detection results using a single camera and includes the snap icon 322 and the pattern matching icon 323 as its internal functions. The snap icon 322 corresponds to a command to capture an object using a single camera. The pattern matching icon 323 corresponds to a command to detect a workpiece by pattern matching with respect to the captured image data. The pattern matching icon 323 includes the condition determination icon 324 as its internal function. The condition determination icon 324 provides a function of specifying the conditions under which various operations are to be performed according to the results of pattern matching.

The vision detection icon 321 controls operations to obtain correction data to correct teaching points in accordance with the workpiece detection results obtained by the snap icon 322 and the pattern matching icon 323. The functions of these icons can realize the vision detection and history storage process illustrated as the flowchart in FIG. 4.

In this embodiment, as the manners of setting storage conditions for determining whether to save the history information, the following manners can be adopted.
(1) using a user-specified storage condition.
(2) detecting outliers to perform abnormality detection.
(3) constructing storage conditions by learning.
(4) using a predefined storage condition.

### (1) The Manner of Using a User-Specified Storage Condition is Described.

The manner of using the user-specified storage condition includes the manner of setting the storage condition in the text-based program illustrated in FIG. 5 and the manner of setting the storage condition via the user interface in the command icon program illustrated in FIG. 6. Here, the latter is described in detail.

FIG. 7 is an example of a user interface screen 330 for detailed setting of the condition determination icon 324. The user interface screen 330 includes a value setting field 341 for specifying the type of value to be used for the condition determination and a condition setting field 342 for specifying the condition by the set value. In the illustrated example, the score obtained as the result of the pattern matching is specified as the setting of value. In addition, “If the value is greater than a constant (0.0 here)” is specified as the setting of condition. The user interface screen 330 further includes a pop-up 343 for specifying the action to be taken when the condition is met. The menu of this pop-up 343 includes an item 344, “Save History Image”. Thus, by including the setting of values and conditions for saving the history image in the user interface screen 330 for detailed setting of the condition determination icon 324, it is possible to save the history image (history information) under various types of conditions. Although FIG. 7 illustrates an example of providing the item “Save History Image” as the operation when the condition is met, the user interface screen 330 may be configured to further provide the item “Save Only History Information Other Than History Images”. This can allow a user to select whether to include images as the history information to be stored. In this case, the amount of data to be stored can be reduced or minimized. The user interface screen 330 may be configured to present a menu that allows a user to select the information to be saved (the target to be saved) as a condition for saving. In this configuration, when the condition is met, only the information selected as the storage target can be stored in the storage device 60.

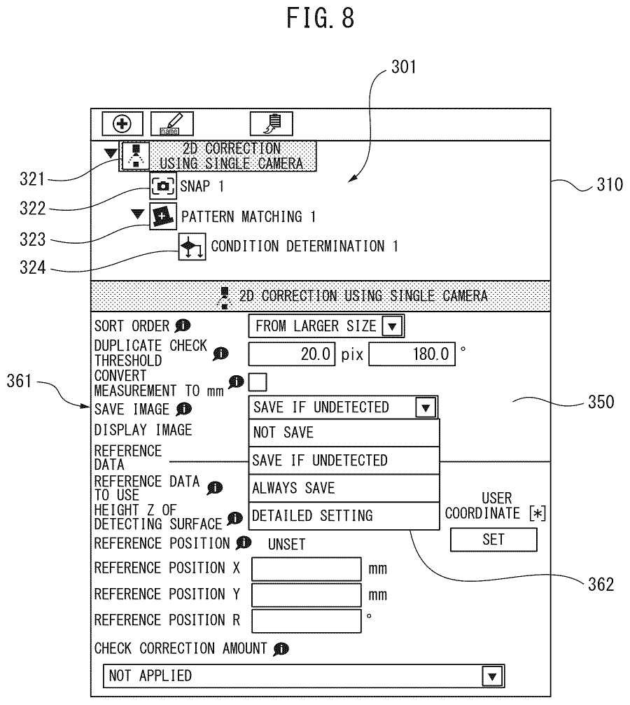

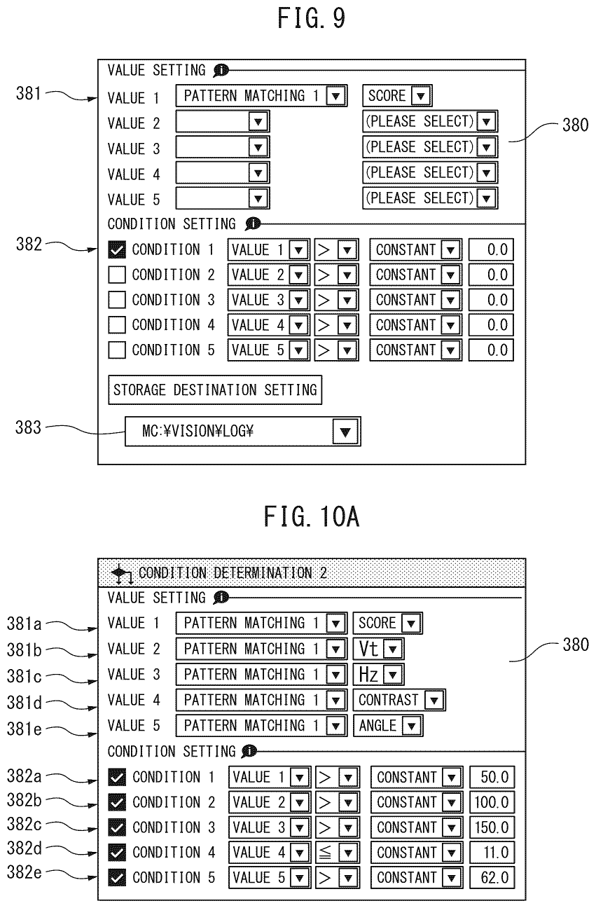

A user interface screen 350 for detailed settings of the vision detection icon 321 illustrated in FIG. 8 may be used as a user interface for setting storage conditions. The user interface screen 350 is configured to include items for specifying conditions for saving history information. The user interface screen 350 illustrated in FIG. 8 can be activated by performing a specified operation with the vision detection icon 321 selected on the program creation screen 310. The user interface screen 350 of FIG. 8 includes a “Detailed Setting” item 362 in the settings menu of an item 361 for specifying save of images. Here, by selecting the “Detailed Setting” item 362, a condition setting screen 380, which is the user interface for specifying storage conditions, illustrated in FIG. 9 can be displayed.

The condition setting screen 380 in FIG. 9 includes a “Value Setting” item 381 for setting the type of value to be used as a condition and a “Condition Setting” item 382 for setting conditions for the set value. In the example in FIG. 9, “If the score is greater than 0.0”, wherein the score is obtained as a result of the pattern matching, is specified as a storage condition. The condition setting screen 380 may further include an item 383 for specifying a destination to save the history image when the condition is met.

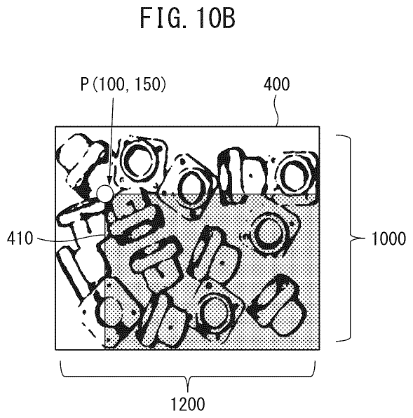

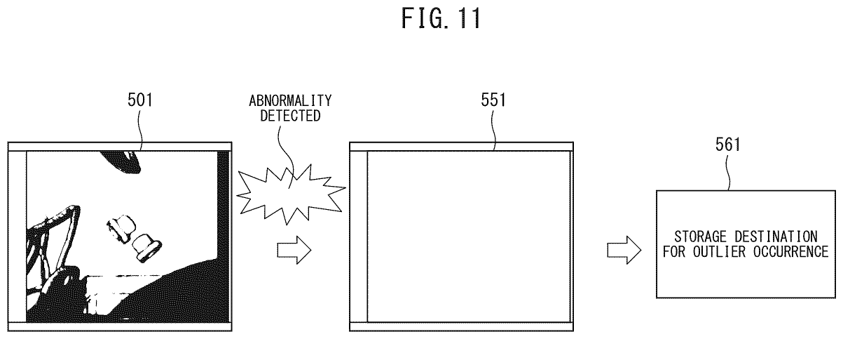

Examples of setting storage conditions via the condition setting screen 380 in FIG. 9 will be described with reference to FIGS. 10A and 10B. FIG. 10A illustrates an example of setting storage conditions via the condition setting screen 380. The setting of values in FIG. 10A include the setting of the following five types of values to be used for setting conditions. Here, the values are specified as parameters obtained as a result of execution of a certain pattern matching operation.
Value 1: Score of the result of pattern matching (reference number 381a)
Value 2: Vertical position in an image for specifying a range of detection position (reference number 381b)
Value 3: Horizontal position in the image for specifying the range of detection position (reference number 381c) Value 4: Contrast of the image (reference number 381d)
Value 5: Angle of the detected object (reference number 381e)

In the condition setting screen in FIG. 10A, the “Setting Condition” item includes the following five conditions for setting conditions using the above Values 1 through 5.
Condition 1: The score (Value 1) to be greater than 50, which is a constant (reference number 382a)
Condition 2: The detection position (Value 2) to be in a range greater than vertical position 100 in the image (reference number 382b)
Condition 3: The detection position (Value 3) to be in a range greater than the horizontal position 150 in the image (reference number 382c)
Condition 4: The contrast (Value 4) of the image to be equal to or less than 11 (reference number 382d)
Condition 5: The rotation angle of the workpiece as a detection result (Value 5) to be greater than 62 degrees (reference number 382e)

Condition 1 is the condition that history information is saved when the score of the detection result (a value representing proximity to the taught model) exceeds 50. When Conditions 2 and 3 are set simultaneously, the condition is to save the history information when the detected range of the workpiece W is within a vertical range of position 100 or more and a horizontal range of position 150 or more in the image 400. This range is illustrated in FIG. 10B, specified as a dot meshing range 410. Such a setting is useful when, for example, the range of detection targets in the image 400 is to be limited. Condition 4 is the condition that the history information is saved when the contrast of the detected image is equal to or less than 11. Condition 5 is a condition to save the history information when the angle (how much the object is rotated with respect to the taught model data) as a detection result of the object is greater than 62 degrees.

In addition to the above examples of storage conditions, storage conditions may be specified in accordance with detection results unique to individual detection methods, such as “diameter,” which is a feature unique to circle detection.

### (2) Detecting Outliers to Perform Abnormality Detection

The following describes the operation when history information is saved in accordance with the result of the outlier detection by the outlier detection section 156. The image 501 illustrated on the left side in FIG. 11 is an example of an image obtained when the detection is finished in a normal state. On the other hand, if the visual sensor 71 has an abnormality such as a damaged lens, an image without contrast, such as an image 551, is considered to be captured for example. Such an abnormality can be detected as an outlier in the contrast of the history image. The outlier detection unit 156 detects the situation in which an accident such as damage to the visual sensor 71 is occurring by detecting an outlier in the captured image data. When such an outlier is detected, the history storage unit 155 saves the captured image as an image in an abnormal state. As a storage destination in this case, a dedicated storage destination 561 for outlier occurrence may be set. The storage destination 561 may be preset or be settable by a user.

For example, score, contrast, position, angle, and magnitude can be used as decision criteria (parameters) for detecting occurrences of abnormality (outliers). Here, the contrast is a contrast of the detected image, and the position, the angle, and the magnitude respectively represent differences from a position, an angle, and a magnitude in the teaching data of the detected object. The conditions for determining an abnormal condition are, for example, the score being lower than a predetermined value, the contrast being lower than a predetermined value, the difference in the position of the detected object relative to the position of the taught model data being larger than a predetermined threshold, the rotation angle of the detected object relative to the rotational position of the taught model data being larger than a predetermined threshold, and the difference of size of the detected object relative to the size of the taught model data being greater than a predetermined threshold.

As a specific example for setting the threshold for detecting an outlier, an average value of the detection values obtained as the results of pattern matching under normal conditions may be used as a reference, and when a detection value obtained as a result of pattern matching deviates much more than the reference (less than 10% of the average value, for example), it may be determined to be an outlier. The standard deviation may be used as an indicator for detecting outliers. For example, a detection value that falls outside the range of three standard deviations may be considered an outlier. Alternatively, a detection value of the latest detection result may be considered correct, and only the latest detection result may be used as a reference to determine the outlier. Other methods known in the art may be used to detect outliers.

Such anomaly detection by detecting outliers can be positioned as “unsupervised learning” because it can be said that storage conditions are set when outliers occur, even if storage conditions are not set beforehand.

### (3) Constructing Storage Conditions by Learning

The learning unit 157 is configured to learn the relationship between one or more data (parameters) included in the history information as the detection results by the visual sensor 71 and the storage conditions. The learning of the storage conditions by the learning unit 157 is described below. Here, although there are various methods for learning, supervised learning, which is a type of machine learning, is exemplified here. Supervised learning is a learning method that constructs a learning model by using labeled data as the teacher data.

The learning unit 157 constructs a learning model using the teacher data including, as the input data, the data pertaining to the history information obtained as the result of the execution of the vision detection function and including, as the label, the information pertaining to the storage of the history information. Once the learning model is constructed, it can be used as the storage condition. As an example, a three-layer neural network with an input layer, an intermediate layer, and an output layer may be used to construct the learning model. It is also possible to use a neural network with three or more layers, so-called deep learning method, to perform learning.

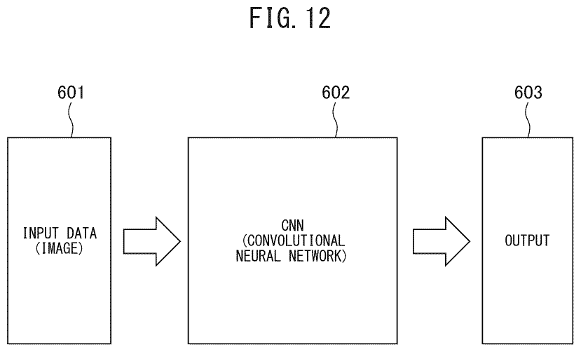

When using, as the input data, history images obtained as history information, a convolutional neural network (CNN) may be used. In this case, as illustrated in FIG. 12, the teacher data including, as input data 601 to a CNN 602, the history image and including, as a label (output) 603, information related to the storage of history information is used to learn the weighting parameters in the CNN 602 by the error back propagation method.

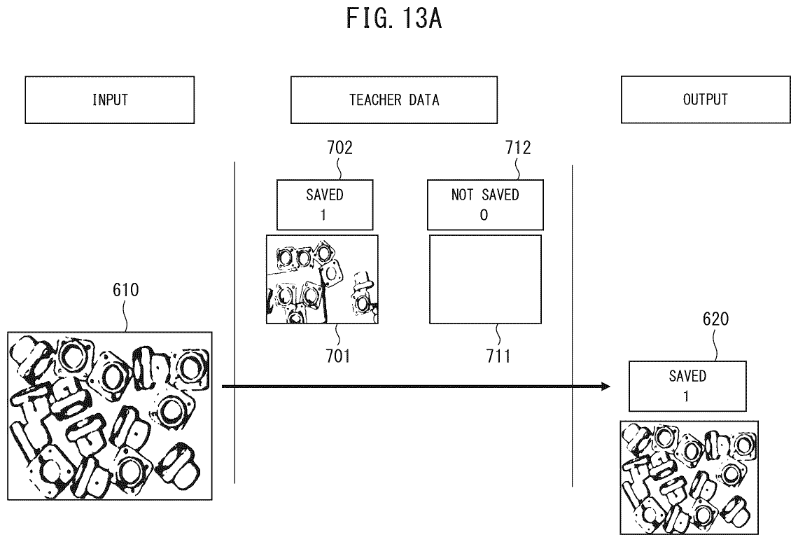

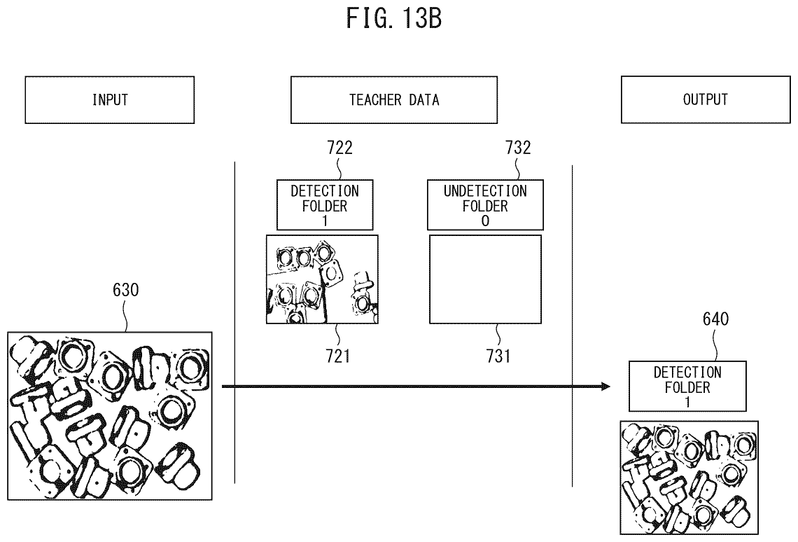

Examples of learning using detected images are explained below. In the first example, machine learning (supervised learning) is performed by using teacher data in which the detected image is set as input data and labels “assigning “1” for saving” and “assigning “0” for not saving” are set as output labels. As illustrated in FIG. 13A, the detected image is assigned the label “saved “1”” as a label 702 when the user saved the image, the label “not saved “0”” as a label 712 when the user did not save the image, and then the learning is performed with these labels as teacher data. When a learning model has been constructed by the learning using a sufficient number of teacher data (training data), the output 620 indicating whether the image should be saved is obtained when the input image 610 illustrated in FIG. 13A is input to the learning model as test data.

The second example of learning using detected images is machine learning (supervised learning), where the detected images are given as the input data and the storage destination as the output labels, and these are used as teacher data. For example, as illustrated in FIG. 13B, if the detected image is saved in a storage destination folder where the detection results are saved, “Detection Folder “1”” is assigned, as a label 722, to the detected image. On the other hand, if the detected image is stored in the “Undetection Folder” where history images are stored when an object is undetected, “Undetection Folder “0”” is assigned, as a label 732, to the detected image. Then, machine learning is performed using these as teacher data (training data). Once a learning model is constructed by machine learning, when an input image 630 illustrated in FIG. 13B is given as the test data, an output 640 indicating the storage location is obtained.

By using the learning function for learning the storage destination illustrated in the second example (second learning function) together with the learning function for learning whether to save the history information illustrated in the first example (first learning function), the teaching device 30 can also be configured to automatically save the history information to be saved to the desired destination.

As another example of a case when storage conditions are constructed by learning, data related to detection results other than images can be used. For example, it is possible to learn from the teacher data using one of the following parameters as input data: score, contrast, position of the detected object, angle of the detected object, or size of the detected object, and using as a label whether the history image has been saved. In this case, regression or classification may be used as the learning (supervised learning) method. As an example, by using the score and the data indicating whether the history image has been saved as teacher data, a relationship between the score and whether the image should be saved (e.g., save the history image when the score is 50 or higher) can be obtained.

In this way, the learning unit 157 constructs a learning model by learning the relationship between the input data contained in the history information and the outputs related to the storage of the history information (i.e., the storage conditions). Therefore, once the learning model is constructed, it is possible, thereafter, to obtain whether the history information should be saved as the output of the learning model by inputting the input data to the learning model, or to obtain the destination for the history information to be saved.

### (4) Using Predefined Storage Conditions

The above describes when the storage condition is set as the text-based command, as setting information for the command icon, as the outlier detection operation, or by learning, but the storage condition may be set in advance in the memory (memory 42, etc.) in the teaching device 30.

As explained above, this embodiment allows history information to be stored under flexible conditions. It is thereby possible to suppress consumption of memory capacity and increase of cycle time associated with storage of the history information.

The history information is useful for knowing under what circumstances an object can or cannot be detected and is useful for improving the object detection method or reviewing the detection environment. By making the conditions for storing history information flexible and allowing a user to set the conditions according to his/her intention, as in this embodiment, it is possible to efficiently collect only history information that is useful for improving the detection method.

Although the present invention has been described above using typical embodiments, those skilled in the art will understand that changes and various other modifications, omissions, and additions can be made to each of the above embodiments without departing from the scope of the present invention.

The functional blocks configured in the robot controller illustrated in FIG. 3 may be realized by a processor of the robot controller executing various software stored in a storage device, or by a hardware-based configuration such as an ASIC (Application Specific Integrated Circuit).

Programs for executing various processes such as vision detection and history storage processes in the above-mentioned embodiments may be stored in various computer-readable recording media (e.g., semiconductor memory such as ROM, EEPROM and flash memory, magnetic recording media, or optical disks such as CD-ROM, DVD-ROM, etc.).

### REFERENCE SIGNS LIST

10 Robot
11 Hand
20 Visual sensor controller
30 Teaching device
40 Teach pendant
41 Processor
42 Memory
43 Display unit
44 Operation unit
45 Input/output interface
50 Robot controller
51 Processor
52 Memory
53 Input/output interface
54 Operation unit
60 Storage device
71 Visual sensor
81 Worktable
100 Robot system
141 Program creation unit
142 User interface creation unit
143 Operation input reception unit
144 Program generation unit
151 Operation control unit
152 Memory unit
152a Storage condition
153 Storage condition setting unit
154 Determination unit
155 History storage unit
156 Outlier detection unit
157 Learning unit
201 Program
210, 310 Program creation screen
301 Vision detection program
330, 350 User Interface screen
380 Condition setting screen
601 Input data
602 Convolutional neural network
603, 702, 712, 722, 732 Label

1. A teaching device, comprising:
a determination unit configured to determine whether a storage condition related to a result of processing on an object by a visual sensor is satisfied; and
a history storage unit configured to store history information obtained as the result of the processing in a storage device when the storage condition is determined to be satisfied.

2. The teaching device according to claim 1, wherein
the storage condition includes a condition specifying a storage destination for saving the history information, and
the history storage unit saves the history information to the storage destination specified by the storage condition.

3. The teaching device according to claim 1, wherein
the storage condition includes a condition that specifies, out of the history information, a target item to be stored, and
the history storage unit stores the target item to be stored out of the history information.

4. The teaching device according to claim 1, further comprising a storage condition setting unit configured to set the storage condition.

5. The teaching device according to claim 4, wherein the storage condition setting unit accepts setting of the storage condition by a text-based command.

6. The teaching device according to claim 4, wherein the storage condition setting unit presents a user interface for setting the storage condition on a display and accepts setting of the storage condition via the user interface.

7. The teaching device according to claim 1, further comprising a learning unit configured to learn the storage condition based on the history information,
wherein the determination unit uses the storage condition obtained through learning by the learning unit.

8. The teaching device according to claim 7, wherein
the learning unit performs a first learning using teacher data including the history information as an input and information indicating whether the history information has been saved as an output label, and
the determination unit uses a learning model obtained by the first learning as the storage condition.

9. The teaching device according to claim 8, wherein
the learning unit further performs a second learning using teacher data including the history information as an input and a storage destination of the history information as an output label, and
the history storage unit uses a learning model obtained by the second learning to determine a storage destination when storing the history information.

10. The teaching device according to claim 1, further comprising an outlier detection unit configured to detect whether there is an outlier in predetermined data included in the history information, and
wherein the determination unit uses whether the outlier is detected by the outlier detection unit as the storage condition.

11. The teaching device according to claim 10, wherein the history storage unit saves the history information to a predetermined storage destination when the outlier is detected.
